(19) United States
(12) Patent Application Publication
(10) Pub. No.: US 2026/0233881 A1
(43) Pub. Date: Aug. 13, 2026

(54) MULTILAYER PET BOTTLES WITH LOW LIGHT TRANSMITTANCE

(71) Applicant: THE COCA-COLA COMPANY, Atlanta, GA (US)

(72) Inventors: Gracy WINGKONO, Atlanta, GA (US); Ky LAYFIELD, Atlanta, GA (US); Marion Salvador MORALES, Atlanta, GA (US)

(73) Assignee: THE COCA-COLA COMPANY, Atlanta, GA (US)

(21) Appl. No.: 19/153,632

(22) PCT Filed: Feb. 7, 2024
(86) PCT No.: PCT/US2024/014733

§ 371 Date: Aug. 5, 2025

Related U.S. Application Data
(60) Provisional application No. 63/484,220, filed on Feb. 10, 2023.

(51) Int. Cl. B65D 1/02; A23L 2/54; B32B 1/00; B32B 27/08; B32B 27/20; B32B 27/30; B32B 27/36; B65D 81/30; B65D 85/80

(52) U.S. Cl. CPC B65D 1/0215; A23L 2/54; B32B 1/00; B32B 27/08; B32B 27/20; B32B 27/306; B32B 27/36; B65D 81/30; B65D 85/80; B32B 2250/03; B32B 2250/24; B32B 2307/41; B32B 2307/7244; B32B 2307/7376; B32B 2439/70

(57) ABSTRACT

Multilayer bottles contain a core layer having a first side and a second side, the core layer comprising an opacifying additive and a core polyester polymer, a hydrolyzable polymer, or a combination thereof, an inner layer positioned on the first side of the core layer, the inner layer comprising a first polyester polymer, and an outer layer positioned on the second side of the core layer, the outer layer comprising a second polyester polymer. The multilayer bottles have a light transmittance of less than or equal to 1% at a wavelength in the 400 to 700 nm range and an ash content of less than or equal to 1 wt. %.

### REFERENCE TO RELATED APPLICATION

This application is being filed on Feb. 7, 2024, as a PCT International Patent Application and claims the benefit of and priority to U.S. Provisional Patent Application No. 63/484,220, filed on Feb. 10, 2023, the disclosure of which is incorporated herein by reference in its entirety.

### FIELD OF THE INVENTION

The present disclosure relates generally to multilayer bottles containing at least three layers, and more particularly, to such bottles having low light transmittance and being substantially free of inorganic pigments or colorants.

### BACKGROUND OF THE INVENTION

Bottles for use as containers for dairy products or beverages have certain structural, light barrier, and oxygen barrier properties to ensure product quality and a desirable shelf-life. However, in meeting these requirements, ease of recyclability may be adversely impacted. It would be beneficial if the bottle structure and composition could be designed to maintain the current structural, light barrier, and oxygen barrier properties but with improved recyclability. Accordingly, it is to these ends that the present disclosure is generally directed.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Multilayer bottles are disclosed and described herein. A representative multilayer bottle can comprise (a) a core layer having a first side and a second side, the core layer comprising an opacifying additive and a core polyester polymer, a hydrolyzable polymer, or a combination thereof, (b) an inner layer positioned on the first side of the core layer, the inner layer comprising a first polyester polymer, and (c) an outer layer positioned on the second side of the core layer, the outer layer comprising a second polyester polymer. The multilayer bottle can be characterized by a light transmittance of less than or equal to 1% at a wavelength in the 400 to 700 nm range and an ash content of less than or equal to 1 wt. %. These multilayer bottles can contain, or can be configured to contain, a dairy product or a carbonated soft drink, although not limited thereto.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURES

FIG. 1 presents an illustration of a 3-layer bottle structure according to an aspect of the present invention.

FIG. 2 presents an illustration of a 4-layer bottle structure according to an aspect of the present invention.

FIG. 3 presents an illustration of a 5-layer bottle structure according to an aspect of the present invention.

FIG. 4 presents an illustration of a 7-layer bottle structure according to an aspect of the present invention.

FIG. 5 is a photograph of the multilayer bottle and multilayer preform of Example 1.

FIG. 6 is a photograph showing the test panel location for the multilayer bottle of Example 1.

FIG. 7 is a plot of light transmittance (%) versus wavelength (nm) for the bottles of Example 1 and Comparative Example 2.

FIG. 8 is a plot of light transmittance (%) versus wavelength (nm) for the bottles of Examples 3-6 and Comparative Example 7.

FIG. 9 is a plot of light transmittance (%) versus wavelength (nm) for the bottles of Examples 3-4 and Comparative Example 7.

FIG. 10 is a plot of light transmittance (%) versus wavelength (nm) for the bottles of Examples 8-9.

### DEFINITIONS

To define more clearly the terms used herein, the following definitions are provided. Unless otherwise indicated, the following definitions are applicable to this disclosure. If a term is used in this disclosure but is not specifically defined, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the designs, compositions, processes, or methods described herein are contemplated and can be interchanged, with or without explicit description of the particular combination. Accordingly, unless explicitly recited otherwise, any aspect or feature disclosed herein can be combined to describe inventive designs, compositions, processes, or methods consistent with the present disclosure.

While compositions and methods are described herein in terms of “comprising” various components or steps, the compositions and methods also can “consist essentially of” or “consist of” the various components or steps, unless stated otherwise. For example, a multilayer bottle consistent with aspects of the present invention can comprise; alternatively, can consist essentially of; or alternatively, can consist of; a core layer, an inner layer, and an outer layer.

The terms “a,” “an,” and “the” are intended to include plural alternatives, e.g., at least one, unless otherwise specified. For instance, the disclosure of “a first polyester polymer” or “a second polyester polymer,” is meant to encompass one, or mixtures or combinations of more than one, first polyester polymer or second polyester polymer, unless otherwise specified.

The term “contacting” is used herein to refer to materials or components which can be blended, mixed, slurried, dissolved, reacted, treated, compounded, or otherwise combined in some other manner or by any suitable method. The materials or components can be contacted together in any order, in any manner, and for any length of time, unless otherwise specified.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, the relative thickness of the core layer as compared to the total thickness of the multilayer bottle can be in certain ranges in various aspects of this invention. By a disclosure that the thickness of the core layer can be in a range from 1% to 25% of the total bottle thickness, the intent is to recite that the thickness of the core layer can be any amount within the range and, for example, can be in any range or combination of ranges from 1% to 25%, such as from 3% to 20%, from 5% to 15%, or from 7% to 13%, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

### DETAILED DESCRIPTION OF THE INVENTION

Disclosed herein are multilayer bottles with improved recyclability and that contain substantially no inorganic pigments or colorants. These multilayer bottles can have (a) a core layer having a first side and a second side, the core layer comprising an opacifying additive and a core polyester polymer, a hydrolyzable polymer, or a combination thereof, (b) an inner layer positioned on the first side of the core layer, the inner layer comprising a first polyester polymer, and (c) an outer layer positioned on the second side of the core layer, the outer layer comprising a second polyester polymer. The multilayer bottle can be characterized by a light transmittance of less than or equal to 1% at a wavelength in the 400 to 700 nm range and an ash content of less than or equal to 1 wt. %.

While not wishing to be bound by the following theory, it is believed that an opaque multilayer bottle structure in which the inner and outer layers contain, for example, clear PET and the core layer contains an opacifying additive and a suitable PET or hydrolyzable polymer (or a combination of these polymers), but is devoid of inorganic pigments and colorants, will enable such opaque bottles to be easily recycled together with a PET bottle stream at existing Material Recovery Facilities (MRF) operating at scale.

### Multilayer Bottles

Aspects of this invention are directed to multilayer bottles comprising (or consisting essentially of, or consisting of) (a) a core layer having a first side and a second side, the core layer comprising an opacifying additive and a core polyester polymer, a hydrolyzable polymer, or a combination thereof, (b) an inner layer positioned on the first side of the core layer, the inner layer comprising a first polyester polymer, and (c) an outer layer positioned on the second side of the core layer, the outer layer comprising a second polyester polymer. In some aspects, the multilayer bottle can have the three layers described generally as an inner layer, a core layer, and an outer layer, while in other aspects, the multilayer bottle can have four or more layers. Thus, the core layer is not limited only to a middle layer in between an inner layer and the outer layer, i.e., other layers can be present. The inner layer and the outer layer are described as being positioned on a first and a second side, respectively, of the core layer. An additional layer, or layers, can be between the core layer and the inner layer, and likewise, between the core layer and the outer layer.

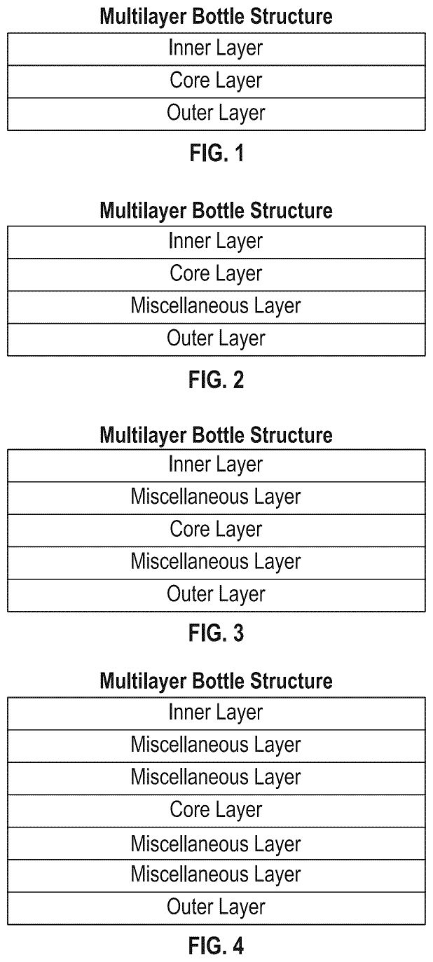

Various combinations of layers can be present in the multilayer bottles consistent with this invention. FIGS. 1-4, respectively, illustrate representative 3-layer, 4-layer, 5-layer, and 7-layer multilayer bottle structures. These and other non-limiting layer configurations follow below, in which letters are used to represent the bottle layers: I/C/O, I/M/C/O, I/C/M/O, I/M/M/C/O, I/M/C/M/O, I/C/M/M/O, I/M/M/C/M/O, I/M/C/M/M/O, I/M/M/M/C/O, I/M/M/C/M/M/O, I/M/M/M/C/M/O, and I/M/C/M/M/M/O. In these examples, “C” represents a core layer, “I” represents an inner layer, “O” represents an outer layer, and “M” represents a miscellaneous or intermediate layer. Optionally, the inner layer, the outer layer, or both can be coated with an additional material. Layers which are next to each other are described as being affixed to or adjacent to each other. For instance, in the multilayer structure I/M/C/O, the “O” layer is adjacent to or affixed to the second side of the “C” layer, and the “O” layer is also positioned on the second side of the “C” layer. Likewise, the “I” layer is not adjacent to or affixed to the first side of the “C” layer, but is positioned on the first side of the “C” layer. Hence, by referring to a given layer as positioned on a side of the core layer, the given layer can be adjacent to or affixed to the core layer, or an additional layer or layers (for example, “M”) can be between the given layer and the core layer. There is no upper limit on the total number of layers in a multilayer bottle in accordance with this invention, for instance, 7-layer and 9-layer structures, provided that the inner layer, core layer, and outer layer are present within the multilayer bottle structure. Materials which can be used in the inner layer, core layer, outer layer, and miscellaneous layer(s) are described herein, and can be utilized in any combination without limitation to further describe the multilayer bottle structure.

FIG. 1 illustrates a 3-layer bottle with an I/C/O layer configuration. Specifically, in this multilayer bottle, the inner layer is adjacent the first side of the core layer, and the outer layer is adjacent the second side of the core layer. As described above and illustrated in FIGS. 2-4, multilayer bottles contemplated herein can have four or more layers, e.g., the multilayer bottle can have five layers or seven layers. Accordingly, a miscellaneous or intermediate layer (or layers) can be between the inner layer and the core layer and/or between the outer layer and the core layer.

In one aspect, the multilayer bottle can be a 3-layer structure, in which the inner layer is adjacent the first side of the core layer, and the outer layer is adjacent the second side of the core layer. In another aspect, the multilayer bottle is a 5-layer structure (or a 7-layer structure, or a 9-layer structure), in which a first intermediate layer is (or two or more first intermediate layers are) positioned between the inner layer and the core layer, and a second intermediate layer is (or two or more second intermediate layers are) positioned between the outer layer and the core layer.

Multilayer bottles described herein are not limited to any particular wall thickness, however, multilayer bottles useful in many end-use applications generally have an average wall thickness in a range from 100 to 500 microns. In certain aspects, the average wall thickness can be in a range from 150 to 400 microns, from 175 to 350 microns, from 200 to 400 microns, or from 200 to 300 microns, and the like.

The core layer of the multilayer bottle can comprise, on average, from 1% to 25% or from 3% to 20% of the total wall thickness in some aspects, while the core layer can comprise, on average, from 5% to 15% or from 7% to 13% of the total wall thickness in other aspects. Likewise, the outer layer and the inner layer of the multilayer bottle, independently, can comprise, on average, from 30% to 60%; alternatively, from 35% to 55%; alternatively, from 35% to 50%; or alternatively, from 40% to 50%, of the wall thickness. Totals of these layer percentages of the inner layer, core layer, and outer layer do not exceed 100%, but in instances where the total is less than 100%, the remaining thickness can come from one or more miscellaneous layers, as described herein. For example, an illustrative multilayer bottle can have a 10% core layer, a 45% inner layer, and a 45% outer layer. As another example, an illustrative multilayer bottle can have a 15% core layer, a 30% inner layer, a 40% outer layer, and a 15% miscellaneous layer between the inner layer and the core layer.

Beneficially, the multilayer bottle in accordance with the present invention can have a relatively low oxygen transmission rate, such that oxidative deterioration of the contents of the bottle are reduced (for a particular set of storage conditions and shelf-life). For instance, the bottle can have an oxygen transmission rate (OTR) in a range from 0.05 to 100cc/m²/day. More often, the OTR of the bottle can be from 0.1 to 50 in one aspect, from 1 to 30 in another aspect, from 2 to 25 in yet another aspect, and from 0.05 to 5 cc/m²/day in still another aspect. The oxygen transmission rate (OTR) is measured with any suitable gas permeability equipment, such as Mocon OX-TRN Model 2/61, at 25° C. and 50% RH.

Multilayer bottles described herein can have relatively high opacity in order to prevent UV/light-induced deterioration of the contents of the bottle (for a particular set of storage conditions and shelf-life). In one aspect, for instance, the bottle can have a light transmittance of less than or equal to 1% (or less than or equal to 0.8%, or less than or equal 0.6%, or less than or equal to 0.4%, or less than or equal to 0.2%) at a wavelength in the 400 to 700 nm range. In another aspect, the bottle can have a light transmittance of less than or equal to 1% (or less than or equal to 0.8%, or less than or equal 0.6%, or less than or equal to 0.4%, or less than or equal to 0.2%) at a wavelength in the 400 to 670 nm range. In yet another aspect, the bottle can have a light transmittance of less than or equal to 1% (or less than or equal to 0.8%, or less than or equal 0.6%, or less than or equal to 0.4%, or less than or equal to 0.2%) at any suitable range of wavelengths (e.g., from 400 to 550 nm) in the 400 to 700 nm range (or the 400 to 670 nm range). In still another aspect, the bottle can have a light transmittance of less than or equal to 1% (or less than or equal to 0.8%, or less than or equal 0.6%, or less than or equal to 0.4%, or less than or equal to 0.2%) over the range of (all) wavelengths in the 400 to 670 nm range. The light transmittance features of the multilayer bottle are determined by UV-Vis as described further herein. Light transmittance is the ratio of light intensity of the radiation leaving the substrate (e.g., bottle wall) to the light intensity that is applied as the incident radiation on the substrate. The measurement of these intensities is perpendicular to the radiation direction on the substrate surface.

Advantageously, the disclosed multilayer bottles are substantially free of inorganic pigments or colorants, such as titanium dioxide (TiO2). Thus, the aforementioned light transmittance features can be achieved without the traditional requirement of high loadings of pigments or colorants. One measure of this feature is the ash content of the multilayer bottles, which typically can be less than 1 wt. %. In some aspects, the bottle can have lower ash content, such as less than or equal to 0.5 wt. %, less than or equal to 0.3 wt. %, or less than or equal to 0.2 wt. %, while in other aspects, the bottle can have even lower ash content, such as less than or equal to 0.1 wt. %, less than or equal to 0.05 wt. %, or less than or equal to 0.01 wt. %. The ash content is the amount of material (in weight percentage) remaining at 800° C. in a TGA test. A PerkinElmer Pyris 1 TGA unit was used with a sample size of approximately 25 mg, gas environment of air (20 mL/min), and heating rate of 10° C./min.

Multilayer bottles described herein can be used in a variety of end-use applications, For instance, the multilayer bottle can contain (or can be configured to contain) a dairy product or a carbonated soft drink.

Any suitable method can be used to produce the multilayer bottle. The multilayer bottle can be produced using an overmolding process, or the multilayer bottle can be produced by injection molding a multilayer preform, and then blow molding the multilayer preform, or the multilayer bottle can be produced by blow molding a coextruded (multilayer) polymer flow. This invention is not limited by any particular technique or methodology that is used to produce the multilayer bottle.

In aspects in which the multilayer bottle is produced by injection molding a multilayer preform, and then blow molding the multilayer preform, often the average wall thickness of the preform is in the 2-5 mm range, and the average wall thickness of the bottle is in the 200 to 500 micron range. Typical drawdown ratios from preform thickness to bottle thickness can be around 10:1, although drawdown ratios in the 5:1 to 20:1 range also are suitable.

While not necessarily limited thereto-particularly when the core layer contains a polymer that is not a polyester-the multilayer bottle can contain, in one aspect of this invention, at least 97 wt. % polyester. In another aspect, the multilayer bottle can contain at least 98 wt. % polyester, and in yet another aspect, the multilayer bottle can contain at least 99 wt. % polyester, and in still another aspect, the multilayer bottle can contain at least 99.5 wt. % (or at least 99.7 wt. %) polyester. Additionally or alternatively, the multilayer bottle often can contain less than or equal to 5 wt. % or less than or equal to 3 wt. % of the opacifying additive, and this can vary significantly based on the relative thickness of the core layer. Nonetheless, in some aspects, the multilayer bottle can contain less than or equal to 2 wt. % of the opacifying additive; alternatively, less than or equal to 1.5 wt. % of the opacifying additive; alternatively, less than or equal to 1 wt. % of the opacifying additive; alternatively, less than or equal to 0.5 wt. % of the opacifying additive; or alternatively, less than or equal to 0.25 wt. % of the opacifying additive. Illustrative and non-limiting ranges for the amount of the opacifying additive in the multilayer bottle can include from 0.1 to 3 wt. %, from 0.25 to 2 wt. %, from 0.25 to 1.5 wt. %, from 0.35 to 2 wt. %, from 0.35 to 1.5 wt. %, from 0.5 to 1.5 wt. %, or from 0.5 to 1 wt. %, of the opacifying additive.

### Core Layer

The core layer of the multilayer bottle can comprise an opacifying additive and a core polyester polymer, a hydrolyzable polymer, or a combination thereof. Thus, in one aspect, the core layer can comprise a core polyester polymer, while in another aspect, the core layer can comprise a hydrolyzable polymer, and in yet another aspect, the core layer can comprise a core polyester polymer and a hydrolyzable polymer in any suitable relative amount. The core layer, in certain aspects of this invention, does not contain a pigment or colorant.

Referring first to aspects in which the core layer comprises the hydrolyzable polymer, any suitable hydrolyzable polymer can be present in the core layer. However, the hydrolyzable polymer is generally selected such that flakes of the bottle will delaminate and/or the core layer will dissolve in an agitated 1 wt. % NaOH in water solution at 85° C. in less than or equal to 30 min, and beneficially, in a time period of less than or equal to 25 min, less than or equal to 20 min, or less than or equal to 15 min. The flakes of the bottle generally are of any suitable size that is less than or equal to 12 mm in diameter, or less than or equal to 9.5 mm in diameter. Additionally or alternatively, the hydrolyzable polymer present in the core layer can be any polymer such that flakes of the bottle meet the PET-P-04 test of the Association of Plastic Recyclers (2019).

The hydrolyzable polymer can include any suitable water soluble polymer, and the polymer can be natural or synthetic, and can be homopolymer or a copolymer. Representative and non-limiting examples of hydrolyzable polymers that can be present in the core layer of the multilayer bottle include a polyvinyl alcohol (PVOH), a partially hydrolyzed polyvinyl alcohol ester, a partially hydrolyzed polyvinyl acetate, or a polyglycolic acid (PGA), and the like. Mixtures or combinations of two of more hydrolyzable polymers (or a mixture of a hydrolyzable polymer and a non-hydrolyzable polymer) can be utilized in the core layer. In some aspects, for example, the hydrolyzable polymer can comprise a polyvinyl alcohol (PVOH), while in other aspects, the hydrolyzable polymer can comprise a polyglycolic acid (PGA).

Regardless of the type of hydrolyzable polymer, such polymer can be further characterized by its degree of hydrolyzation. Often, the degree of hydrolyzation of the hydrolyzable polymer ranges from 50% to 99%, and more often, the degree of hydrolyzation of the hydrolyzable polymer falls within a range from 60% to 95%, from 70% to 90%, or from 70% to 85%. If the degree of hydrolyzation is too high, the bottle will not delaminate and/or the core layer will not dissolve quickly enough in the caustic solution during the recycling process.

Although the inner layer and the outer layer (and if present, other intermediate or miscellaneous layers) can contribute to the opacity of the multilayer bottle, the vast majority of the opacity—and low light transmittance—comes from the core layer, The opacity/light transmittance properties often can result from light scattering, or from light absorption, or from light reflection, or any combination thereof, in the core layer. In an aspect, the opacity of the core layer can result, at least in part, from foaming the hydrolyzable polymer. Thus in this aspect, the core layer can comprise a foamed hydrolyzable polymer.

Referring now to aspects in which the core layer comprises the core polyester polymer, illustrative and non-limiting examples of polymers that can be utilized as the core polyester polymer can include a polyethylene terephthalate (PET), a glycol-modified PET (PET-G), a recycled PET (R-PET), a polybutylene terephthalate, a polylactic acid (PLA), a polyhydroxyalkanoate (PHA), or combinations thereof. In an aspect, the core polyester polymer can have a density of at least 1.05 g/cc, at least 1.1 g/cc, or at least 1.2 g/cc.

As described herein, in addition to the core polyester polymer and/or the hydrolyzable polymer, the core layer can contain an opacifying additive. Generally, the core layer contains at least 50 wt. %, at least 75 wt. %, at least 80 wt. %, at least 85 wt. %, at least 90 wt. %, at least 95 wt. %, at least 98 wt. %, or at least 99 wt. % of polymer components (polyester and/or hydrolyzable polymer(s)). Accordingly, the amount of the opacifying additive (or a total of opacifying additives, if more than one) in the core layer often is less than or equal to 50 wt. %, less than or equal to 25 wt. %, less than or equal to 15 wt. %, less than or equal to 12 wt. %, less than or equal to 10 wt. %, less than or equal to 8 wt. %, less than or equal to 5 wt. %, or less than or equal to 2 wt. %. Typical ranges of the opacifying additive in the core layer can include, but are not limited to, from 1 to 20 wt. %, from 2 to 15 wt. %, from 3 to 20 wt. %, from 4 to 15 wt. %, or from 5 to 12 wt. %, of the opacifying additive.

While not limited thereto, the opacifying additive can comprise any suitable organic opacifier, i.e., the opacifying additives is not a mineral or a pigment. As an example, the opacifying additive can comprise a polyolefin without colorant that provides opacity, which may or may not be miscible or compatible with the polymer(s) in the core layer. Illustrative and non-limiting examples of the opacifying additive include a polymethylpentene, a cyclic olefin copolymer, a hydrogenated styrenic polymer or copolymer, a siloxane, a solid light scattering pigment, cristobalite, and the like, as well as any mixture or combination thereof. Representative cyclic olefin copolymers include ethylene/norbornene copolymers, ethylene/tetracyclodecene copolymers, and the like, and combinations of two or more cyclic olefin copolymers can be utilized as the opacifying additive. Representative solid light scattering pigments include, for instance, titanium dioxide, metal oxide particles, barium sulfate, zinc sulfide, and the like, as well as combinations thereof.

In an aspect, an opacifying additive suitable for use in the core layer can have a DSC melt point in a range from 200 to 250° C., such as from 210 to 250° C., from 225 to 240° C., or from 230 to 235° C., and the like. Additionally or alternatively, the opacifying additive can have a glass transition temperature (Tg) in a range from 115 to 145° C. in one aspect, from 120 to 140° C. in another aspect, from 120 to 135° C. in yet another aspect, and from 125 to 130° C. in still another aspect. As disclosed herein, the opacifying additive can be a polymer that is immiscible or incompatible with the polymer(s) used in the core layer.

### Inner and Outer Layers

The multilayer bottles described herein can comprise (a) a core layer having a first side and a second side, the core layer comprising an opacifying additive and a core polyester polymer, a hydrolyzable polymer, or a combination thereof, (b) an inner layer positioned on the first side of the core layer, the inner layer comprising a first polyester polymer, and (c) an outer layer positioned on the second side of the core layer, the outer layer comprising a second polyester polymer. In some aspects, the inner layer and the outer layer can have the same composition—comprise the same polymer or the same blend of polymers, or alternatively, the inner layer and the outer layer can have different compositions—comprise different polymers or a different blend of polymers.

Illustrative and non-limiting examples of polymers that can be utilized as the first polyester polymer and/or the second polyester polymer can include a polyethylene terephthalate (PET), a glycol-modified PET (PET-G), a recycled PET (R-PET), a polybutylene terephthalate, a polylactic acid (PLA), a polyhydroxyalkanoate (PHA), or combinations thereof. In an aspect, the first polyester polymer and the second polyester polymer can comprise the same polymer, although this is not a requirement, and optionally, the first polyester polymer and the second polyester polymer independently can have a density of at least 1.05 g/cc, at least 1.1 g/cc, or at least 1.2 g/cc. In addition to the first polyester polymer in the inner layer and the second polyester polymer in the outer layer, the inner layer and the outer layer do not contain a pigment or colorant in certain aspects of this invention.

As an example, a typical bottle structure can be PET/core layer/PET, with the core layer selections described above. The PET can be from any source (e.g., virgin, recycled, enhanced recycled) or any combination of sources in different relative amounts. Enhanced recycled refers to PET that has been depolymerized to its monomer(s) and then repolymerized to PET.

Generally, the inner layer contains at least 90 wt. %, at least 95 wt. %, at least 98 wt. %, or at least 99 wt. % of the first polyester polymer, and the outer layer contains at least 90 wt. %, at least 95 wt. %, at least 98 wt. %, or at least 99 wt. % of the second polyester polymer.

### Other Layers and Additives

In some aspects of this invention, the multilayer bottle can comprise a miscellaneous or intermediate layer. Any miscellaneous or intermediate layer (one, or more than one) that may be present in the multilayer bottle can comprise any of the polymers discussed above as being polymer options for the core layer, inner layer, and/or outer layer. Optionally, a miscellaneous or intermediate layer can be a tie layer, and/or a miscellaneous or intermediate layer can be a layer comprising regrind. A tie layer can be used to promote adhesion between any two layers, such as between the core layer and the inner layer.

Additives are often used in polymer bottles and formulations to improve the processing or ease of manufacturing of the polymer(s) and the multilayer bottle. Another use of additives is to impart a certain property or characteristic to the multilayer bottle. In aspects of the present invention, one or more additives can be employed in the inner layer, and/or the outer layer, and/or the core layer, and/or any of the miscellaneous or intermediate layers that may be present. Suitable additives which can be employed in the multilayer structures or formulations disclosed herein can include, but are not limited to, antioxidants, acid scavengers, antiblock additives, slip additives, colorants, fillers, polymer processing aids, UV inhibitors, and the like, including combinations thereof. Such materials are well known to those of skill in the art and are described, for example, in the Modern Plastics Encyclopedia, Mid-November 1995 Issue, Vol. 72, No. 12; and Film Extrusion Manual−Process, Materials, Properties, TAPPI Press, 1992.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

### Example 1 and Comparative Example 2

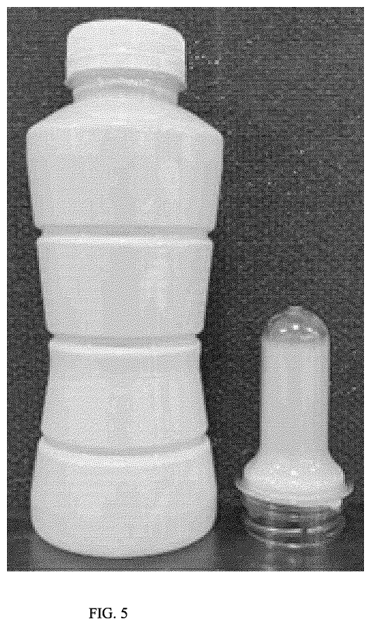

FIG. 5 is a photograph of the multilayer bottle and multilayer preform of Example 1, which were produced as follows. Multilayer A/B/A injection molded preforms were first prepared using an Arburg injection molding unit with a 165 ton clamp and a 2-cavitation tooling mold to produce 21.2 g preforms with a 38 mm finish, an overall length of 69.1 mm, a maximum wall thickness of 3.4 mm, and a gate vestige diameter of 4 mm. The extrusion system was configured to produce preforms having 45/10/45 layer ratios (thus, a 10% core layer). The inner and outer (“A”) layers were 100 wt. % PET (DAK B90A) and the core layer was a mixture of 92.5 wt. % PET (DAK B90A) and 7.5 wt. % of an opacifying additive. The amount of the opacifying additive in the overall multilayer bottle structure, therefore, was 0.75 wt. %. Prior to molding, all PET materials were dried to a level of less than 20 ppm H₂O. TGA testing on the opacifying additive showed no significant amount of ash (less than 0.5 wt. %), which translates to less than 50 ppm in the overall multilayer bottle structure. The opacifying additive had two DSC melt points at temperatures of approximately 230° C. and 234° C., as well as a glass transition temperature (Tg) of approximately 130° C.

The extruder feeding the inner and outer layers had a 30 mm screw diameter and a 25:1 L/D ratio, while the extruder feeding the core layer had a 16 mm screw diameter and a 25:1 L/D ratio. All melt channels in the injector and hot runner units (feed zone, metering zone, sprue, manifolds, and nozzle temperatures) were all set at 280° C. Injector A had a fill position of 58 mm and fill speed of 21.2 mm/sec, and injector B had a fill position of 27 mm and fill speed of 25 mm/sec. Injector B filled core layer (10 wt. %) for a length of 55 mm positioned between the finish and endcap of the preform. The holding phase process time was 8.5 sec, the cooling phase process time was 6 sec, and the tooling mold cooling circuits were 10° C. The total injection molding process time was 25.7 sec.

The injection molded preforms were blow molded using a Sidel blow molding unit at a preform temperature of 138° C. Blow molding processing parameters included a pre-blow time of 0.14 sec, a blowing time of 0.912 sec, a compensation time of 1.34 sec, and an exhaust time of 0.2 sec. The blow molding unit was equipped with a 14 mm flat stretch rod and cooling shields were set at 2 mm away from the preform and 2 mm above the neck support ledge. The pre-blow pressure set point was 8 bar and the flow limiter was set at 150. Pre-blow delay was 2.50/10. The high blow pressure used was 35 bar. The stretching speed was 1.9 m/s. Mold cooling circuits were set at 12° C.

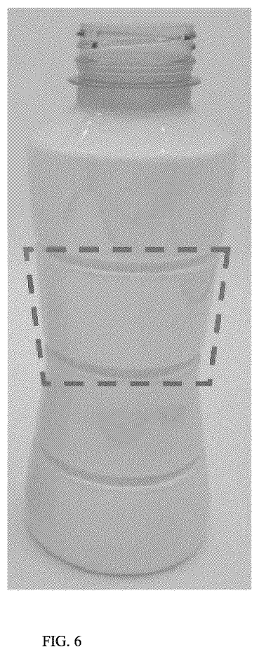

The wall thickness and light transmittance properties of the multilayer bottle of Example 1 and Comparative Example 2 were tested. The multilayer bottle of Example 1 was configured to hold approximately 11.5 fluid oz. Comparative Example 2 was a white pigmented monolayer bottle (containing ~3 wt. % TiO₂ in the overall structure) and configured to hold approximately 14 fluid oz. FIG. 6 is a photograph showing the test panel location for the multilayer bottle of Example 1, which is the second panel from the top of the bottle. Thus, bottle thickness and light transmittance were tested on this section of the multilayer bottle. Average bottle thicknesses for the bottles of Example 1 and Comparative Example 2 were both 0.30 mm (300 microns).

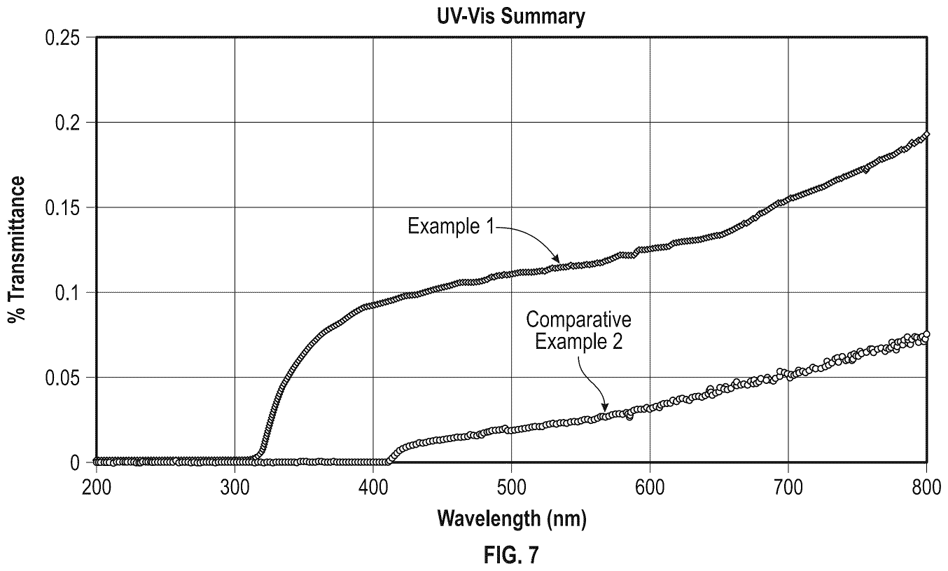

Light transmittance was measured using a Thermo Fisher Scientific Evolution 300 UV-Vis Spectrophotometer and the following test parameters: baseline correction of 100% T Baseline, % Transmittance data mode, wavelength range of 200-800 nm, bandwidth of 2 nm, scan speed of 240 nm/min, data interval of 1 nm, xenon lamp change, 1 cycle, and cycle time set to auto. The results of the light transmittance testing for the bottles of Example 1 and Comparative Example 2 are summarized in FIG. 7. Note that both bottles had light transmittance values much less than 1%—and much less than 0.25%—across all wavelengths in the 200 to 800 nm range. While the bottles of Example 1 did not provide light transmittance values as low as the bottles of Comparative Example 2, the light transmittance values for the bottles of Example 1 in the 400 to 700 nm range were in the very low range of 0.1-0.15%. And beneficially, the bottles of Example 1 had an ash content of less than 50 ppm (such as from inorganic pigments or colorants).

In sum, it was unexpected that only 7.5 wt. % of the opacifying additive in the core layer of the multilayer bottle of Example 1 (and only 0.75 wt. % of the opacifying additive in the overall multilayer bottle structure) would result in such low light transmittance values. Extremely high light protection with much lower additive loading, as compared to monolayer bottles, was achieved by placing the opacifying additive only in the core layer and subjecting the bottle, during manufacture, to sufficient orientation during molding to dramatically increase its light blocking properties.

### Examples 3-6 and Comparative Example 7

Examples 3-6 were produced in the same manner as that of Example 1, but with the following layer configurations and compositions. Example 3 had a 47.5/5/47.5 layer ratio (thus, a 5% core layer). The inner and outer (“A”) layers were 100 wt. % PET (DAK B90A) and the core layer was a mixture of 90 wt. % PET (DAK B90A) and 10 wt. % of the same opacifying additive as in Example 1. The amount of the opacifying additive in the overall multilayer bottle structure of Example 3, therefore, was 0.5 wt. %.

Example 4 had a 46.25/7.5/46.25 layer ratio (thus, a 7.5% core layer). The inner and outer (“A”) layers were 100 wt. % PET (DAK B90A) and the core layer was a mixture of 90 wt. % PET (DAK B90A) and 10 wt. % of the same opacifying additive as in Example 1. The amount of the opacifying additive in the overall multilayer bottle structure of Example 4, therefore, was 0.75 wt. %.

Example 5 had a 47.5/5/47.5 layer ratio (thus, a 5% core layer). The inner and outer (“A”) layers were 100 wt. % PET (DAK B90A) and the core layer was a mixture of 95 wt. % PET (DAK B90A) and 5 wt. % of the same opacifying additive as in Example 1. The amount of the opacifying additive in the overall multilayer bottle structure of Example 5, therefore, was 0.25 wt. %.

Example 6 had a 46.25/7.5/46.25 layer ratio (thus, a 7.5% core layer). The inner and outer (“A”) layers were 100 wt. % PET (DAK B90A) and the core layer was a mixture of 95 wt. % PET (DAK B90A) and 5 wt. % of the same opacifying additive as in Example 1. The amount of the opacifying additive in the overall multilayer bottle structure of Example 6, therefore, was 0.375 wt. %.

The wall thicknesses and light transmittance properties of the multilayer bottles of Examples 3-6 and Comparative Example 7 were tested. The multilayer bottles of Example 3-6 were configured to hold approximately 11.5 fluid oz. Comparative Example 7 was a white pigmented monolayer bottle (containing ~3 wt. % TiO₂ in the overall structure) similar to Comparative Example 2 and configured to hold approximately 14 fluid oz. Bottle thickness and light transmittance were tested on the same section of the multilayer bottle as in Example 1 and Comparative Example 2. Average bottle thicknesses for the bottles of Examples 3-6 were 0.26-0.27 mm (260-270 microns), and the average bottle thickness for the bottles of Comparative Example 7 were 0.30 mm (300 microns).

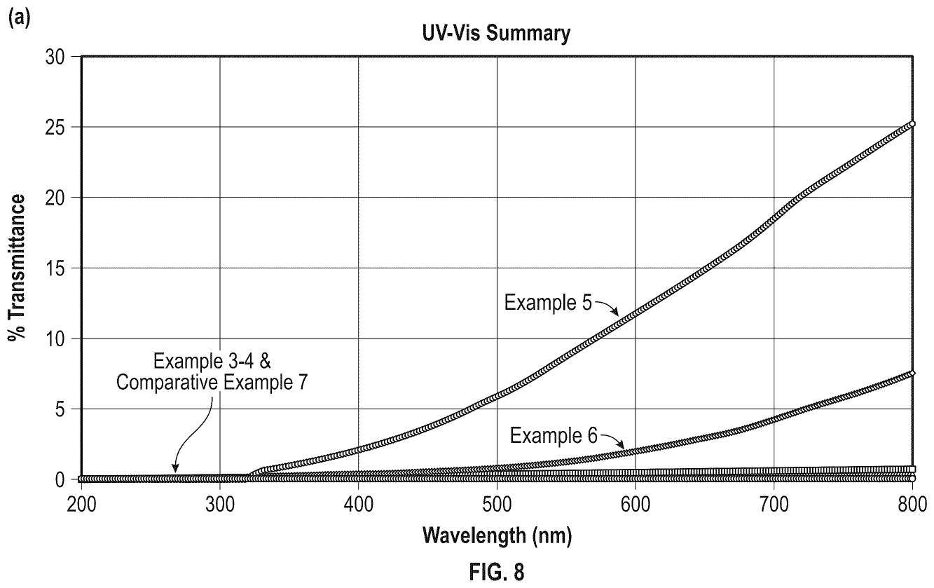

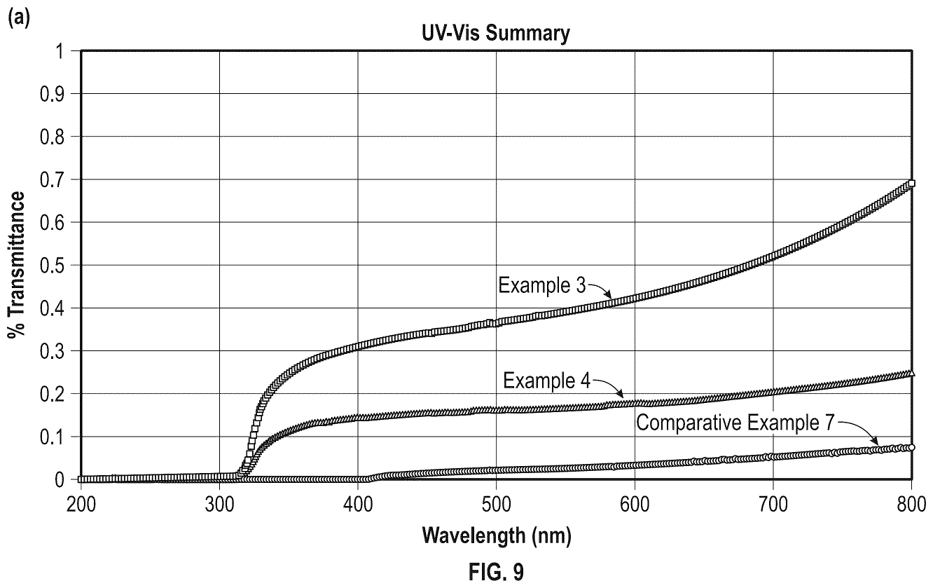

The results of the light transmittance testing for the bottles of Example 3-6 and Comparative Example 7 are summarized in FIGS. 8-9. While the light transmittance values were less than 1% for the bottles of Examples 5-6 at lower wavelengths, the light transmittance values were not less than 1% across all wavelengths in the 200 to 800 nm range, as shown in FIG. 8. Note that Examples 5-6 has the lowest amounts of the opacifying additive in the overall multilayer bottle structure, ranging from 0.25 wt. % to 0.375 wt. %.

The results of the light transmittance testing for the bottles of Examples 3-4 and Comparative Example 7 are shown in FIG. 9 with a maximum light transmittance (y-axis) of 1%. Beneficially, all bottles had light transmittance values much less than 1% across all wavelengths in the 200 to 800 nm range. While the bottles of Examples 3-4 did not provide light transmittance values as low as the bottles of Comparative Example 7, the light transmittance values for the bottles of Example 3 and Example 4 in the 400 to 670 nm range were in the very low range of 0.3-0.5% and 0.1-0.2%, respectively. And beneficially, the bottles of Examples 3-4 had substantially no ash content (such as from inorganic pigments or colorants).

In sum, it was unexpected that only 0.5 wt. % and 0.75 wt. % of the opacifying additive in the overall multilayer bottle structure of Examples 3-4 would result in such low light transmittance values. Extremely high light protection with much lower additive loading, as compared to monolayer bottles, was achieved by placing the opacifying additive only in the core layer and subjecting the bottle, during manufacture, to sufficient orientation during molding to dramatically increase its light blocking properties.

### Examples 8-9

Examples 8-9 were produced in the same manner as that of Example 1, but with the following layer configuration and compositions. Example 8 had a 45/10/45 layer ratio (thus, a 10% core layer). The inner and outer (“A”) layers were 100 wt. % PET (DAK B90A) and the core layer was a mixture of 92.5 wt. % PET (DAK B90A) and 7.5 wt. % of the same opacifying additive as in Example 1. The amount of the opacifying additive in the overall multilayer bottle structure of Example 8, therefore, was 0.75 wt. %.

Example 9 had a 46.5/7/46.5 layer ratio (thus, a 7% core layer). The inner and outer (“A”) layers were 100 wt. % PET (DAK B90A) and the core layer was a mixture of 85 wt. % PVOH (Kuraray Mowilex M-05) and 15 wt. % of the same opacifying additive as in Example 1. The amount of the opacifying additive in the overall multilayer bottle structure of Example 9, therefore, was 1.05 wt. %. PVOH was used as a representative hydrolyzable polymer in the core layer instead of PET.

The wall thicknesses, oxygen transmission rates, and light transmittance properties of the multilayer bottles of Examples 8-9 were tested. The multilayer bottles of Example 8-9 were configured to hold approximately 11.5 fluid oz. Bottle thickness and light transmittance were tested on the same section of the multilayer bottle as in Example 1 and Comparative Example 2. Average bottle thicknesses for the bottles of Examples 8-9 were in the 0.26-0.31 mm (260-310 micron) range. Oxygen transmission rates for Example 8 and Example 9 were 1.6cc/m²/day and 0.23cc/m² /day, respectively, at 25° C. and 50% RH. Unexpectedly, the OTR for Example 9 was almost an order of magnitude less than the OTR for Example 8. These transmission rates were determined by measuring oxygen transmission rates for the overall bottle, and then converted to cc/m²/day based on the surface area of the bottle.

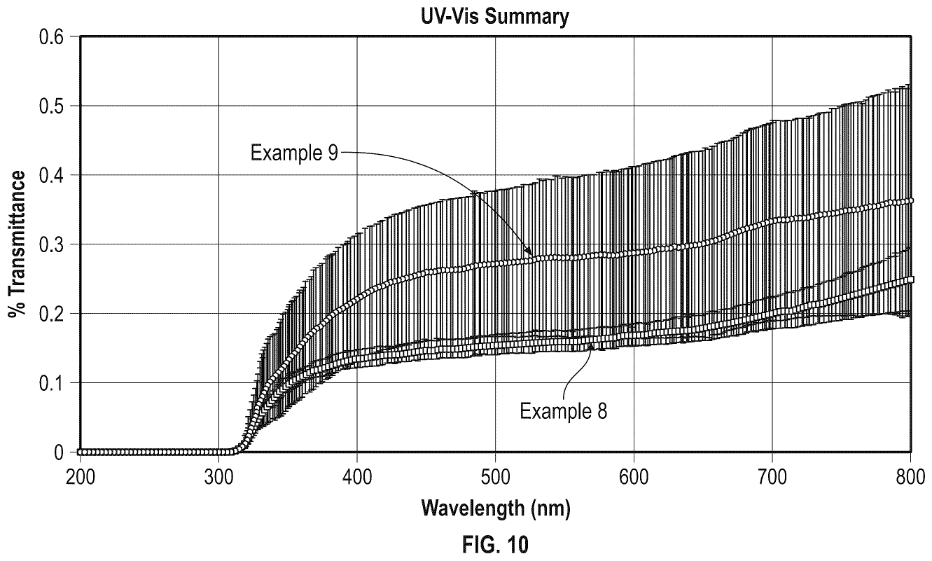

The results of the light transmittance testing (with 95% confidence limits) for the bottles of Examples 8-9 are shown in FIG. 10 with a maximum light transmittance (y-axis) of 0.6%. Beneficially, both bottles had light transmittance values much less than 1% across all wavelengths in the 200 to 800 nm range. The light transmittance values for the bottles of Example 8-9 in the 400 to 670 nm range were in the very low range of less than 0.5%. And beneficially, the bottles of Examples 8-9 had substantially no ash content (such as from inorganic pigments or colorants).

Referring to Example 9, this example demonstrates that very low light transmittance in combination with very low inorganic/ash content can be achieved with polymers other than PET, such as PVOH. Further, although not tested, it is expected that due to the core layer containing the PVOH hydrolyzable polymer, that flakes of the bottle will delaminate and/or the core layer will dissolve in an agitated 1 wt. % NaOH in water solution at 85° C. in less than or equal to 30 min, as described herein and in the PET-P-04 test of the Association of Plastic Recyclers (2019).

### Aspects

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A multilayer bottle comprising (a) a core layer having a first side and a second side, the core layer comprising an opacifying additive and a core polyester polymer, a hydrolyzable polymer, or a combination thereof; (b) an inner layer positioned on the first side of the core layer, the inner layer comprising a first polyester polymer; and (c) an outer layer positioned on the second side of the core layer, the outer layer comprising a second polyester polymer; wherein the bottle is characterized by a light transmittance of less than or equal to 1% at a wavelength in the 400 to 700 nm range; and an ash content of less than or equal to 1 wt. %.

Aspect 2. The bottle defined in aspect 1, wherein the inner layer is adjacent the first side of the core layer.

Aspect 3. The bottle defined in aspect 1, wherein a first intermediate layer is (or two or more first intermediate layers are) positioned between the inner layer and the core layer.

Aspect 4. The bottle defined in any one of aspects 1-3, wherein the outer layer is adjacent the second side of the core layer.

Aspect 5. The bottle defined in any one of aspects 1-3, wherein a second intermediate layer is (or two or more second intermediate layers are) positioned between the outer layer and the core layer.

Aspect 6. The bottle defined in any one of aspects 1-5, wherein the inner layer and the outer layer have the same composition (e.g., same polymer or same blend of polymers).

Aspect 7. The bottle defined in any one of aspects 1-5, wherein the inner layer and the outer layer have different compositions (e.g., different polymers or different blends of polymers).

Aspect 8. The bottle defined in any one of aspects 1-7, wherein the light transmittance is less than or equal to 1% (or less than or equal to 0.8%, or less than or equal 0.6%, or less than or equal to 0.4%, or less than or equal to 0.2%) at a wavelength in the 400 to 670 nm range.

Aspect 9. The bottle defined in any one of aspects 1-7, wherein the light transmittance is less than or equal to 1% (or less than or equal to 0.8%, or less than or equal 0.6%, or less than or equal to 0.4%, or less than or equal to 0.2%) at a range of wavelengths (e.g., from 400 to 550 nm) in the 400 to 700 nm range (or the 400 to 670 nm range).

Aspect 10. The bottle defined in any one of aspects 1-7, wherein the light transmittance is less than or equal to 1% (or less than or equal to 0.8%, or less than or equal 0.6%, or less than or equal to 0.4%, or less than or equal to 0.2%) over the range of (all) wavelengths in the 400 to 670 nm range.

Aspect 11. The bottle defined in any one of aspects 1-10, wherein the ash content is less than or equal to 0.5 wt. %, less than or equal to 0.3 wt. %, less than or equal to 0.2 wt. %, less than or equal to 0.1 wt. %, less than or equal to 0.05 wt. %, or less than or equal to 0.01 wt. %.

Aspect 12. The bottle defined in any one of aspects 1-11, wherein the bottle has a wall thickness (average) in any range disclosed herein, e.g., from 100 to 500 microns, from 150 to 400 microns, from 175 to 350 microns, from 200 to 400 microns, or from 200 to 300 microns.

Aspect 13. The bottle defined in any one of aspects 1-12, wherein the core layer is any (average) percentage of the wall thickness of the bottle disclosed herein, e.g., from 1% to 25%, from 3% to 20%, from 5% to 15%, or from 7% to 13%.

Aspect 14. The bottle defined in any one of aspects 1-13, wherein the outer layer is any (average) percentage of the wall thickness of the bottle disclosed herein, e.g., from 30% to 60%, from 35% to 55%, from 35% to 50%, or from 40% to 50%.

Aspect 15. The bottle defined in any one of aspects 1-14, wherein the inner layer is any (average) percentage of the wall thickness of the bottle disclosed herein, e.g., from 30% to 60%, from 35% to 55%, from 35% to 50%, or from 40% to 50%.

Aspect 16. The bottle defined in any one of aspects 1-15, wherein the core layer comprises the hydrolyzable polymer, and the hydrolyzable polymer comprises any polymer such that flakes (less than or equal to 12 mm or 9.5 mm in diameter) of the bottle delaminate and/or the core layer dissolves in an agitated 1 wt. % NaOH in water solution at 85° C. in less than or equal to 30 min, less than or equal to 25 min, less than or equal to 20 min, or less than or equal to 15 min.

Aspect 17. The bottle defined in any one of aspects 1-16, wherein the core layer comprises the hydrolyzable polymer, and the hydrolyzable polymer comprises any polymer such that flakes of the bottle meet the PET-P-04 test of the Association of Plastic Recyclers (2019).

Aspect 18. The bottle defined in any one of aspects 1-17, wherein the core layer comprises the hydrolyzable polymer, and the hydrolyzable polymer comprises any suitable water soluble polymer, which can be natural or synthetic, and a homopolymer or copolymer.

Aspect 19. The bottle defined in any one of aspects 1-18, wherein the core layer comprises the hydrolyzable polymer, and the hydrolyzable polymer comprises a polyvinyl alcohol (PVOH), a partially hydrolyzed polyvinyl alcohol ester, a partially hydrolyzed polyvinyl acetate, a polyglycolic acid (PGA), or any combination thereof.

Aspect 20. The bottle defined in any one of aspects 1-19, wherein the core layer comprises the hydrolyzable polymer, and the hydrolyzable polymer comprises a polyvinyl alcohol (PVOH).

Aspect 21. The bottle defined in any one of aspects 1-19, wherein the core layer comprises the hydrolyzable polymer, and the hydrolyzable polymer comprises a polyglycolic acid (PGA).

Aspect 22. The bottle defined in any one of aspects 1-21, wherein the core layer comprises the hydrolyzable polymer, and the hydrolyzable polymer has any suitable degree of hydrolyzation, e.g., from 50% to 99%, from 60% to 95%, from 70% to 90%, or from 70% to 85%.

Aspect 23. The bottle defined in any one of aspects 1-22, wherein the core layer comprises the hydrolyzable polymer, and the hydrolyzable polymer comprises a foamed hydrolyzable polymer.

Aspect 24. The bottle defined in any one of aspects 1-23, wherein the core layer comprises the core polyester polymer.

Aspect 25. The bottle defined in any one of aspects 1-24, wherein the bottle comprises at least 97 wt. % polyester, at least 98 wt. % polyester, at least 99 wt. % polyester, at least 99.5 wt. %, or at least 99.7 wt. % polyester.

Aspect 26. The bottle defined in any one of aspects 1-25, wherein the core polyester polymer, the first polyester polymer, and the second polyester polymer independently comprise a polyethylene terephthalate (PET), a glycol-modified PET (PET-G), a recycled PET (R-PET), a polybutylene terephthalate, a polylactic acid (PLA), a polyhydroxyalkanoate (PHA), or combinations thereof.

Aspect 27. The bottle defined in any one of aspects 1-26, wherein the core polyester polymer, the first polyester polymer, and the second polyester polymer independently comprise a polyethylene terephthalate (PET), a glycol-modified PET (PET-G), a recycled PET (R-PET), or a combination thereof.

Aspect 28. The bottle defined in any one of aspects 1-27, wherein the core polyester polymer, the first polyester polymer, and the second polyester polymer independently have a density of at least 1.05 g/cc, at least 1.1 g/cc, or at least 1.2 g/cc.

Aspect 29. The bottle defined in any one of aspects 1-28, wherein the light transmittance of the bottle results from light scattering, light absorption, light reflection, or any combination thereof, in the core layer.

Aspect 30. The bottle defined in any one of aspects 1-29, wherein the core layer comprises less than or equal to 50 wt. %, less than or equal to 25 wt. %, less than or equal to 15 wt. %, less than or equal to 12 wt. %, less than or equal to 10 wt. %, less than or equal to 8 wt. %, less than or equal to 5 wt. %, less than or equal to 2 wt. %, from 1 to 20 wt. %, from 2 to 15 wt. %, from 3 to 20 wt. %, from 4 to 15 wt. %, or from 5 to 12 wt. %, of the opacifying additive.

Aspect 31. The bottle defined in any one of aspects 1-30, wherein the bottle comprises less than or equal to 5 wt. %, less than or equal to 3 wt. %, less than or equal to 2 wt. %, less than or equal to 1.5 wt. %, less than or equal to 1 wt. %, less than or equal to 0.5 wt. %, less than or equal to 0.25 wt. %, from 0.1 to 3 wt. %, from 0.25 to 2 wt. %, from 0.25 to 1.5 wt. %, from 0.35 to 2 wt. %, from 0.35 to 1.5 wt. %, from 0.5 to 1.5 wt. %, or from 0.5 to 1 wt. %, of the opacifying additive.

Aspect 32. The bottle defined in any one of aspects 1-31, wherein the opacifying additive comprises any suitable opacifying additive or any opacifying additive disclosed herein.

Aspect 33. The bottle defined in any one of aspects 1-32, wherein the opacifying additive comprises a polymethylpentene, a cyclic olefin copolymer, a hydrogenated styrenic polymer or copolymer, a siloxane, a solid light scattering pigment, cristobalite, or any combination thereof.

Aspect 34. The bottle defined in any one of aspects 1-33, wherein the opacifying additive has a DSC melt point in a range from 200 to 250° C., from 210 to 250° C., from 225 to 240 ° C., or from 230 to 235° C.

Aspect 35. The bottle defined in any one of aspects 1-34, wherein the opacifying additive has a glass transition temperature (Tg) in a range from 115 to 145° C., from 120 to 140° C., from 120 to 135 ° C., or from 125 to 130° C.

Aspect 36. The bottle defined in any one of aspects 33-35, wherein the solid light scattering pigment comprises titanium dioxide, metal oxide particles, barium sulfate, zinc sulfide, or any combination thereof.

Aspect 37. The bottle defined in any one of aspects 33-36, wherein the cyclic olefin copolymer comprises an ethylene/norbornene copolymer, an ethylene/tetracyclodecene copolymer, or a combination thereof.

Aspect 38. The bottle defined in any one of aspects 1-37, wherein the bottle is characterized by an oxygen transmission rate in a range from 0.05 to 100, from 0.1 to 50, from 1 to 30, from 2 to 25, or from 0.05 to 5 cc/m²/day.

Aspect 39. The bottle defined in any one of aspects 1-38, wherein the first polyester polymer and the second polyester polymer comprise the same polymer.

Aspect 40. The bottle defined in any one of aspects 1-39, wherein the inner layer and the outer layer do not contain a pigment or colorant.

Aspect 41. The bottle defined in any one of aspects 1-40, wherein the core layer does not contain a pigment or colorant.

Aspect 42. The bottle defined in any one of aspects 1-41, wherein the bottle contains (or is configured to contain) a dairy product or a carbonated soft drink.

Aspect 43. The bottle defined in any one of aspects 1-42, wherein the bottle is produced using an overmolding process.

Aspect 44. The bottle defined in any one of aspects 1-42, wherein the bottle is produced by injection molding a multilayer preform, and then blow molding the multilayer preform.

Aspect 45. The bottle defined in any one of aspects 1-42, wherein the bottle is produced by blow molding a coextruded (multilayer) polymer flow.

Aspect 46. A multilayer bottle comprising (a) a core layer having a first side and a second side, the core layer comprising an opacifying additive and a core polyester polymer, a hydrolyzable polymer, or a combination thereof; (b) an inner layer positioned on the first side of the core layer, the inner layer comprising a first polyester polymer; and (c) an outer layer positioned on the second side of the core layer, the outer layer comprising a second polyester polymer; wherein the bottle is characterized by a light transmittance of less than or equal to 1% (or less than or equal to 0.8%, or less than or equal 0.6%, or less than or equal to 0.4%, or less than or equal to 0.2%) at a wavelength in the 400 to 700 nm range; and an ash content of less than or equal to 1 wt. % (or less than or equal to 0.5 wt. %, or less than or equal to 0.3 wt. %, or less than or equal to 0.2 wt. %, or less than or equal to 0.1 wt. %, or less than or equal to 0.05 wt. %, or less than or equal to 0.01 wt. %).

Aspect 47. The bottle defined in aspect 46, wherein the light transmittance is less than or equal to 1% (or less than or equal to 0.8%, or less than or equal 0.6%, or less than or equal to 0.4%, or less than or equal to 0.2%) over the range of (all) wavelengths in the 400 to 670 nm range; the core layer is an average percentage of the wall thickness of the bottle from 1% to 25%, from 3% to 20%, from 5% to 15%, or from 7% to 13%; and the core layer comprises from 1 to 20 wt. %, from 2 to 15 wt. %, from 3 to 20 wt. %, from 4 to 15 wt. %, or from 5 to 12 wt. %, of the opacifying additive and/or the bottle comprises from 0.1 to 3 wt. %, from 0.25 to 2 wt. %, from 0.25 to 1.5 wt. %, from 0.35 to 2 wt. %, from 0.35 to 1.5 wt. %, from 0.5 to 1.5 wt. %, or from 0.5 to 1 wt. %, of the opacifying additive.

Aspect 48. The bottle defined in aspect 46 or 47, wherein the core layer comprises the hydrolyzable polymer, and the hydrolyzable polymer comprises a polyvinyl alcohol (PVOH); or the core layer comprises the core polyester polymer, and the bottle comprises at least 97 wt. % polyester, at least 98 wt. % polyester, at least 99 wt. % polyester, at least 99.5 wt. %, or at least 99.7 wt. % polyester.

1. A multilayer bottle comprising:
(a) a core layer having a first side and a second side, the core layer comprising an opacifying additive and a core polyester polymer, a hydroly zable polymer, or a combination thereof;
(b) an inner layer positioned on the first side of the core layer, the inner layer comprising a first polyester polymer; and
(c) an outer layer positioned on the second side of the core layer, the outer layer comprising a second polyester polymer;
wherein the bottle is characterized by:
a light transmittance of less than or equal to 1% at a wavelength in the 400 to 700 nm range; and
an ash content of less than or equal to 1 wt. %.

2-45. (canceled)

46. The bottle of claim 1, wherein:
the inner layer is adjacent the first side of the core layer; and
the outer layer is adjacent the second side of the core layer.

47. The bottle of claim 1, wherein the inner layer and the outer layer have the same composition.

48. The bottle of claim 1, wherein the light transmittance is less than or equal to 0.2% at the wavelength in the 400 to 670 nm range.

49. The bottle of claim 1, wherein the light transmittance is less than or equal to 1% over all wavelengths in the 400 to 670 nm range.

50. The bottle of claim 1, wherein the ash content is less than or equal to 0.2 wt. %.

51. The bottle of claim 1, wherein the bottle has an average wall thickness in a range from 100 to 500 microns.

52. The bottle of claim 1, wherein the core layer is from 1% to 25% of an average wall thickness of the bottle.

53. The bottle of claim 1, wherein the outer layer is from 30% to 60% and the inner layer is from 30% to 60% of an average wall thickness of the bottle.

54. The bottle of claim 1, wherein the core layer comprises the hydroly zable polymer.

55. The bottle of claim 54, wherein the hydrolyzable polymer comprises a polyvinyl alcohol (PVOH) and/or a polyglycolic acid (PGA).

56. The bottle of claim 1, wherein the core layer comprises the core polyester polymer.

57. The bottle of claim 1, wherein the bottle comprises at least 97 wt. % polyester.

58. The bottle of claim 1, wherein:
the core layer comprises from 1 to 20 wt. % of the opacifying additive; and/or
the bottle comprises from 0.1 to 3 wt. % of the opacifying additive.

59. The bottle of claim 58, wherein the opacifying additive comprises a polymethylpentene, a cyclic olefin copolymer, a hydrogenated styrenic polymer or copolymer, a siloxane, a solid light scattering pigment, cristobalite, or any combination thereof.

60. The bottle of claim 1, wherein the bottle is characterized by an oxygen transmission rate in a range from 0.05 to 100 cc/m²/day.

61. The bottle of claim 1, wherein the first polyester polymer and the second polyester polymer comprise the same polymer.

62. The bottle of claim 1, wherein the inner layer and the outer layer do not contain a pigment or colorant.

63. The bottle of claim 1, wherein the core layer does not contain a pigment or colorant.

64. The bottle of claim 1, wherein the bottle contains a dairy product or a carbonated soft drink.
